(19) United States
(12) Patent Application Publication
(10) Pub. No.: US 2014/0058838 A1
(43) Pub. Date: Feb. 27, 2014

(54) PROVIDING CONTENT IN MULTIPLE LANGUAGES

(71) Applicants: Awaneesh Verma, San Francisco, CA (US); Sharat Chikkerur, Pittsburgh, PA (US)

(72) Inventors: Awaneesh Verma, San Francisco, CA (US); Sharat Chikkerur, Pittsburgh, PA (US)

(73) Assignee: Google Inc.

(21) Appl. No.: 13/593,312

(22) Filed: Aug. 23, 2012

(51) Int. Cl. G06Q 30/02

(52) U.S. Cl. 705/14.54

(57) ABSTRACT

Systems, methods, and computer-readable storage media that may be used to provide advertisements to multilingual users are provided. One method includes receiving a search query in the first language entered by the user into a search engine. The method further includes determining a plurality of languages understood by a user based on one or more inputs received from the user. The plurality of languages includes a first language and a second language. The method further includes identifying, using at least one processing circuit, first advertising content in the first language based on the search query. The method further includes identifying, using the at least one processing circuit, second advertising content in the second language based on the search query. The method further includes providing the first advertising content and the second advertising content to the user.

### BACKGROUND

The Internet enables access to content based in a variety of different languages and originating from various locations around the world. Search engines are typically dedicated to searching content in a particular language. For example, an English-based search engine may provide search results and/or advertising content based in the English language. A Spanish-based search engine may provide search results and/or advertising content based in the Spanish language.

### SUMMARY

One implementation of the disclosure relates to a method that includes receiving a search query in the first language entered by the user into a search engine. The method further includes determining a plurality of languages understood by a user based on one or more inputs received from the user. The plurality of languages includes a first language and a second language. The method further includes identifying, using at least one processing circuit, first advertising content in the first language based on the search query. The method further includes identifying, using the at least one processing circuit, second advertising content in the second language based on the search query. The method further includes providing the first advertising content and the second advertising content to the user.

Another implementation of the disclosure relates to a system including at least one computing device operably coupled to at least one memory and configured to receive a search query in the first language entered by the user into a search engine. The at least one computing device is further configured to determine a plurality of languages understood by a user based on one or more inputs received from the user. The plurality of languages includes a first language and a second language. The at least one computing device is further configured to identify first advertising content in the first language based on the search query. The at least one computing device is further configured to translate the search query into the second language and to identify second advertising content in the second language based on the translated search query. The at least one computing device is further configured to provide the first advertising content and the second advertising content to the user.

Another implementation of the disclosure relates to a computer-readable storage medium having instructions stored thereon that, when executed by a processor, cause the processor to perform operations including receiving a search query in the first language entered by the user into a search engine. The operations further include determining a plurality of languages understood by a user based on one or more inputs received from the user. The plurality of languages include a first language and a second language. The operations further include identifying first advertising content in the first language based on the search query and identifying second advertising content in the second language based on the search query. The operations further include providing the first advertising content and the second advertising content to the user.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an advertisement system and associated environment according to an illustrative implementation.

FIG. 2A is a flow diagram of a process for providing content (e.g., advertising content) in multiple languages according to an illustrative implementation.

FIG. 2B is a flow diagram of another process for providing content (e.g., advertising content) in multiple languages according to another illustrative implementation.

FIGS. 3A through 3D are flow diagrams of processes for determining a plurality of languages understood by a user according to illustrative implementations.

FIG. 4 is an example display image of a search engine results interface through which content (e.g., advertising content) in multiple languages may be provided to a user according to an illustrative implementation.

FIG. 5 is a block diagram of an example computing system according to an illustrative implementation.

### DETAILED DESCRIPTION

Referring generally to the Figures, various illustrative systems and methods are provided that may be used to provide content (e.g., advertisements) based in multiple different languages in response to a search request on a search engine when it is determined that the user is multilingual. Many users of search engines are multilingual. For example, a user of a Thai version of a search engine may speak English as well as Thai. If the user searches on a search engine in Thai, the advertisement server typically will serve advertisements only in the Thai language (e.g., only from Thai language advertisers). The user is not exposed to potentially useful English-language advertisements for the same query.

Illustrative implementations of the disclosure are configured to identify when a user is multilingual and provide advertisements based on the languages that the user is determined to understand. A search term may be received from a user in a first language that the user understands or is assumed to understand (e.g., German), and advertisements may be retrieved in the first language based on the search term. The search term may be machine translated into a second language that the user understands or is assumed to understand (e.g., English), and content in the second language may be retrieved based on the machine translated first term. The content in both the first language and the second language may then be presented to the user. In some implementations, keywords associated with advertisements in the second language may be translated into the first language to identify relevant advertisements in the second language rather than machine translating the search query after it is received from the user.

One or more of several different methods may be used to determine that the user is multilingual. For example, a list of languages the user understands may be received from the user and stored in settings associated with the user. In another example, a mismatch may be identified between the user's user interface language and the language of their current task (e.g., a user searching for an English word on the German version of the search engine). In another example, the languages used by the user when performing previous tasks (e.g., previous searches and/or communications) may be used to determine the languages the user understands. In yet another example, it may be assumed that the user is multilingual and advertisements may be provided in multiple languages. Whether or not the user understands the languages may be determined based on whether the user interacts with (e.g., clicks through) the advertisements in the respective languages. For example, if a user searches for “blumen,” English content for “flowers” may be presented among the German content for “blumen.” If the user interacts positively with the English content (e.g., by clicking through it), it may be inferred that the user understands English.

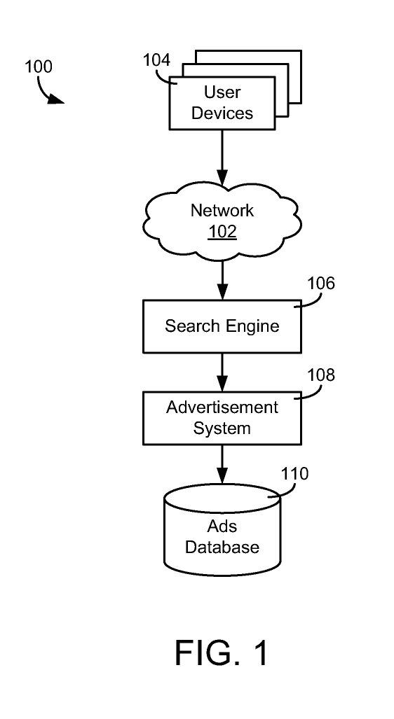

FIG. 1 illustrates a block diagram of an example advertisement system 108 and associated environment 100 according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. Various types of content accessed through user devices 104 may include advertising content designed to encourage users of user devices 104 to purchase certain products and/or services and/or to perform other actions that an advertiser seeks to cause users to perform.

User devices 104 may be any type of computing device (e.g., having a processor and memory or other type of computer-readable medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 may be designed to use various types of software and/or operating systems. In various illustrative implementations, user devices 104 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 may be configured to receive data from various sources using a network 102. In some implementations, network 102 may comprise a computing network (e.g., LAN, WAN, Internet, etc.) to which user devices 104 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

User devices 104 may be configured to search for content on the Internet through the use of a search engine 106. Search engine 106 may be implemented using one or more server computing devices and may be configured to index and search web pages, documents, media, and/or other content accessible via the Internet. A user may navigate to a website associated with search engine 106 that serves as an interface through which search queries can be submitted. A search query includes one or more characters that the user wishes to use as the basis for searching content indexed by search engine 106. After entry of a search query, search engine 106 may be configured to search indexed web pages and/or other content (e.g., based on keywords associated with the web pages and/or other content) to determine results that are most relevant to the search query. Relevant results may then be provided to the user (e.g., on a search results web page).

In some implementations, search engine 106 may include multiple search engines or search engine components based in different languages. For example, search engine 106 may include one search interface based in English, another interface based in Spanish, another based in Chinese, etc. Users may access different versions of search engine 106 at different Internet addresses or URLs. In one illustrative example, a user may access the English version of search engine 106 at a fictional URL www.searchengine.com and the German version of search engine 106 at a fictional URL www.searchengine.de.

In various illustrative implementations, an advertisement system 108 may be used to provide advertisements based on search queries provided to search engine 106. Advertisement system 108 may be configured to retrieve advertisements to be presented from an advertisement database 110 to which advertisement system 108 is communicatively coupled (e.g., a local memory associated with advertisement system 108, a remotely accessible memory, etc.). In some implementations, advertisement system 108 may be configured to access advertisement database 110 through network 102 or another communications network. Advertisement system 108 may be configured to select advertisements based on the search query and based on one or more keywords associated with the advertisements. Advertisement system 108 may determine advertisements to select based on a comparison of the search query to the keywords. In some implementations, advertisements may be selected for a particular query if keywords for the advertisements match one or more terms in the search query, if keywords for the advertisements match synonyms of one or more terms in the search query, if keywords for the advertisements relate to topics considered relevant to the topic of the search query, etc. In some implementations, advertisement system 108 may also be configured to select advertisements to be presented to a particular user based in part on information associated with the user or user device. For example, advertisement system 108 may be configured to determine advertisements to present to a user based on demographic information about the user, a geographic location of the user, interests of the user, etc. In this manner, the user may be more likely to be interested in the displayed advertisement. In some implementations, advertisement system 108 may be configured to rank the advertisements based on relevance to the search query (e.g., in a manner similar to how search engine 106 may rank content results according to relevance to the search query). In some implementations, the advertisements may be ranked based on a measure of the success or popularity of the advertisements, such as a click through rate (CTR). Once advertisement system 108 has selected the advertisements, the advertisements may be transmitted to search engine 106 or to the user device of the user for integration into an advertisements portion of a search results interface.

In some embodiments, advertisements may be ranked based on bids associated with the advertisements. A search engine operator may receive advertising revenue by auctioning a certain set of keywords to advertisers. Advertisers may place auction bids for the ability to include an advertisement on the search result webpage, whenever a user searches using a keyword in the set. For example, an online retailer of golf equipment may participate in an advertising auction for the golf-related set of keywords. If a user searches for the term “golf,” and the retailer is determined to be the winner of the auction, an advertisement from the retailer may appear on the same webpage as the search results. A provider of a website devoted to a particular topic may also receive advertising revenue by auctioning off the ability to place advertisements with his or her website (e.g., embedded in a webpage, in a pop-up window, etc.). Similar to bidding on search results, an advertiser may place a bid in the auction using a set of keywords that corresponds to keywords found in the text of the website.

In one implementation, an advertiser or other party may create an account with an auction server associated with advertisement system 108. Associated with the account may be data relating to which advertisements the advertiser wishes to use, a daily budget to spend, topical categories of webpages on which the advertisement is to be placed (e.g., webpages related to Sports >Golf, etc.), one or more bid amounts, or other data that may be used by the auction server to select advertisements or other content to be displayed by user devices 104. When a user device 104 visits a webpage that participates in the advertising network, the auction server may compare bids among advertisers or other parties to select content to be included on the webpage.

Advertisement system 108 may be configured to present advertisements that are based in different languages. For example, advertisement system 108 may store and index advertisements based in English, Spanish, German, French, Thai, Japanese, and/or any other languages. These advertisements may be presented to users when the users are likely to understand the language of the advertisements. For example, English-based advertisements may be presented within a search results interface of the English version of search engine 106, and French-language advertisements may be presented within a search results interface of the French version of search engine 106. In some implementations, a user input or action may be used to determine a language for the advertisements to be presented to the user. For example, if the user provides a German-language search query to search engine 106, German-language advertisements may be returned by advertisement system 108.

Users of search engines often understand more than one language. For example, it is very common in many countries for citizens to be bilingual or to understand more than two languages. Systems that are configured to present advertisements in only a single language miss a potential revenue generation opportunity by presenting advertisements to such users based in only one of the several languages that the user understands.

Advertisement system 108 is configured to determine when a particular user may be multilingual and to present advertisements to the user based in multiple languages that the user is believed to understand. Advertisement system 108 may be configured to determine two or more languages believed to be understood by the user based on actions of the user. When a search query is received from the user, advertisement system 108 may retrieve advertising content based in two or more of the languages understood by the user to be presented to the user. In some implementations, advertisement system 108 may be configured to translate the search query from a first language in which it was provided to search engine 106 by the user into a second language. The translated search query may then be compared to keywords associated with advertisements in the second language to select advertisements for presentation to the user. In other implementations, keywords associated with advertisements in the second language may be translated into one or more other languages (e.g., when the advertisements are received by advertisement system 108 and/or entered into advertisement database 110), including the first language, rather than translating the search query into the second language after it has been received from the user. When a search query in the first language is received from a user believed to understand the second language, advertisement system 108 may compare the search query with the translated keywords of the advertisements in the second language to determine whether any of the advertisements in the second language should be selected for presentation to the user. The advertisements may be presented to the user in their original base languages (i.e., the first language for advertisements in the first language and the second language for advertisements in the second language).

In some implementations, selected advertisements in the second language may be translated into the first language for presentation to the user. For example, advertisements in the second language may be machine-translated into the first language after selection. In some implementations, advertisements may be provided to advertisement system 108 in multiple languages (e.g., when they are created), and the version of the advertisement corresponding to the first language may be selected for presentation to the user. In some implementations, the advertisements may be presented in the second language, and the user may be enabled to select the advertisements in the second language for translation into the first language. In some implementations, the advertisements may be ranked based in part on a measure of confidence associated with the translation (e.g., whether the translation from the second language into the first language is likely to be more or less accurate).

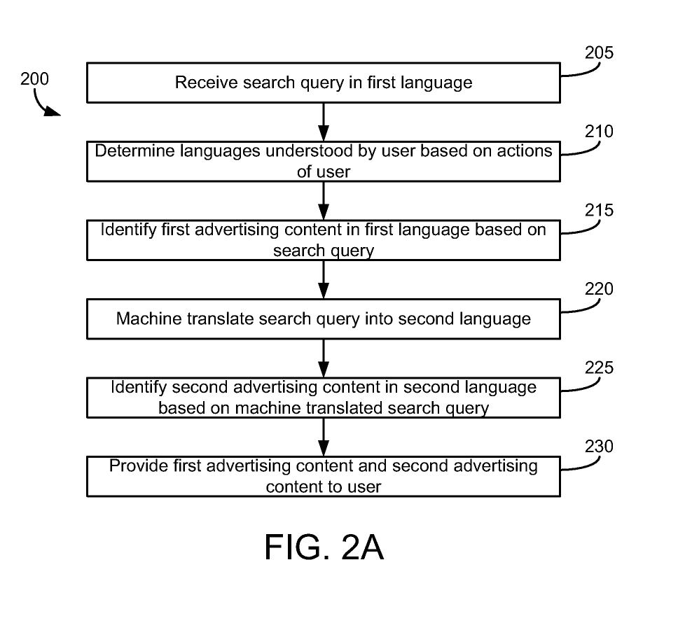

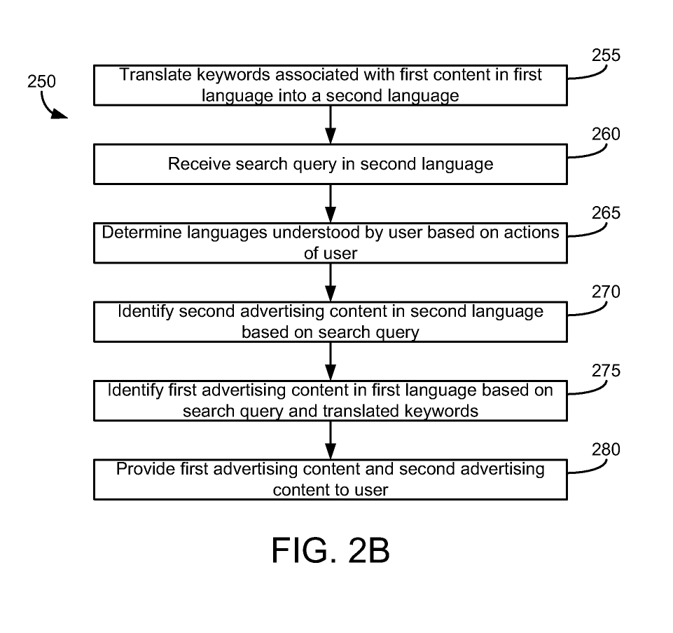

Referring now to FIG. 2A, a flow diagram of a process 200 for providing content (e.g., advertising content) in multiple languages is shown according to an illustrative implementation. In some implementations, some or all of the operations of process 200 may be performed by advertisement system 108 and/or other components of environment 100.

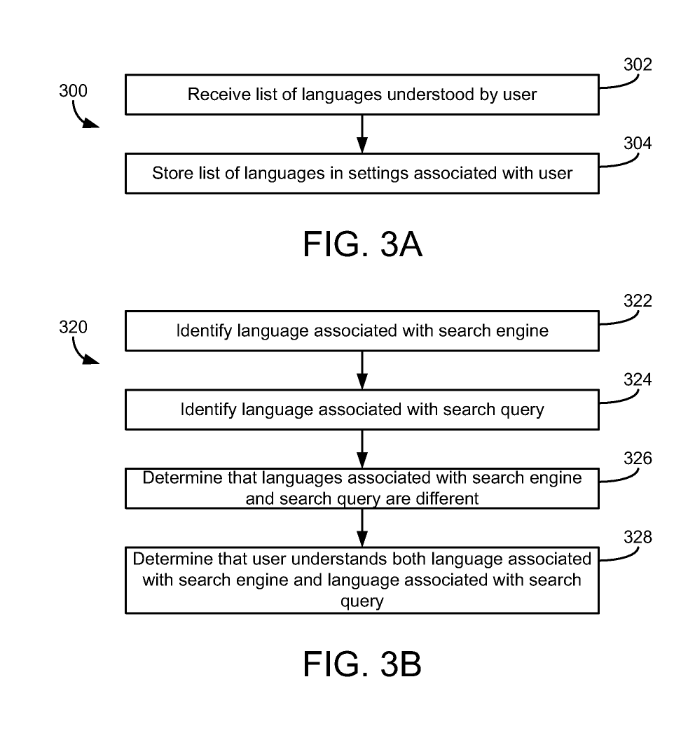

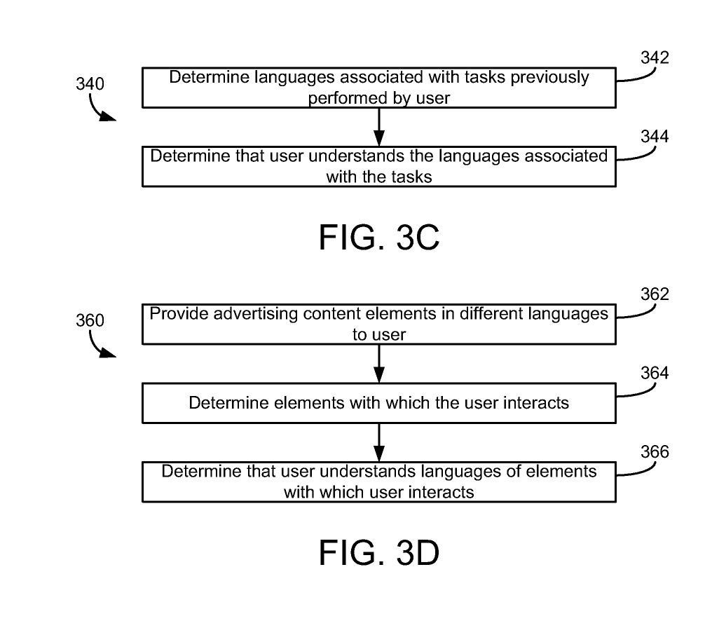

A search query may be received from a user by a search engine and may be forwarded to an advertisement system (205). The search query may be in a first language, such as English. The advertisement system may be configured to determine the languages that the user is believed to understand (210). If the user is believed to understand only the language associated with the search query, the advertisement system may be configured to return advertisements based only in that language. If the user is believed to be multilingual, the advertisement system may select advertisements based in multiple languages understood by the user to be presented to the user. The advertisement system may be configured to determine whether the user is multilingual using any one or more of a variety of different methods. Some illustrative methods that may be used to determine whether a user is multilingual are described in detail herein with respect to FIGS. 3A through 3D.

The advertisement system is configured to identify first advertising content in the first language (e.g., English) based on the search query based in the first language (215). If the user is determined to be multilingual, the advertisement system is configured to translate the search query into a second language (e.g., Spanish) that the user is believed to understand (220). The advertisement system may be configured to perform translation of the search query using a machine translation tool configured to receive input text in a first language and to output corresponding text in a second language. The translated search query may then be compared with keywords of advertisements based in the second language, and the advertisement system may identify one or more second advertising content elements in the second language that are relevant to the translated search query (225). The identified advertising content in the first and second languages may be provided to the user at a user device of the user (230). In some implementations, the identified advertising content may be presented within a single display image in an advertising portion of a search results interface. In some implementations, advertisements may be identified and presented that are based in more than two languages that are believed to be understood by the user. The advertisements in different languages may be presented on a single display screen, for example in an advertisement portion of a search results screen.

In some implementations, the advertisement system may be configured to translate keywords associated with advertisements into multiple other languages rather than translating search queries after they are received from users. FIG. 2B is a flow diagram of a process 250 in which keywords associated with content (e.g., advertising content) are translated into other languages according to an illustrative implementation. In some implementations, some or all of the operations of process 250 may be performed by advertisement system 108 and/or other components of environment 100.

An advertisement system may be configured to receive advertisements based in one or more languages. The advertisement system may be configured to translate keywords associated with advertisements based in a first language (e.g., Spanish) into one or more target languages, including a second language (e.g., English) (255). The translated keywords may be used to determine whether the advertisements should be selected for presentation to users when search queries are received from users who are believed to be multilingual and, are believed to understand the first language.

The advertisement system is configured to receive a search query in the second language (260) and to determine the languages believed to be understood by the user (265). The advertisement system is configured to identify content in the second language based on the search query in the second language (270). If the user is determined to understand both the second language and the first language, the advertisement system is configured to compare the search query in the second language to the keywords that have been translated from the first language to the second language. Based on the comparison, the advertisement system is configured to identify advertising content in the first language that is relevant to the search query (275). The identified advertising content in the first and second languages may be provided to the user at a user device of the user (280).

Any or all of a number of methods may be used to determine whether a user is multilingual and what languages the user understands. FIGS. 3A through 3D describe processes that may be used, alone or in combination with one another, to determine the languages understood by a user, according to illustrative implementations. The processes described with respect to FIGS. 3A through 3D may be implemented by advertisement system 108 and/or other components of environment 100 and may be utilized in the implementation of processes 200 and/or 250 (e.g., operations 210 and/or 265).

FIG. 3A is a flow diagram of an illustrative process 300 in which the languages understood by a user may be determined based on explicit input from the user. The advertisement system and/or search engine may be configured to receive a list of languages understood by the user from the user (302). The list may be obtained by presenting a query to the user inquiring as to what languages the user understands, by enabling the user to specify a list of languages in a settings interface of the search engine and/or advertisement system, or in some other manner. The list of languages may be stored in settings associated with the user and used to determine advertisements to be presented to the user (304).

FIG. 3B is a flow diagram of an illustrative process 320 in which the languages understood by the user may be determined based on identifying a difference in the base language associated with the search engine and the language of the search query provided by the user. The advertisement system may be configured to identify a base language associated with the search engine and/or the search engine interface being used by the user (322). For example, the base language of a search engine interface at www.searchengine.com may be English, and the base language of a search engine interface at www.searchengine.de may be German. The advertisement system may receive a search query from the user and/or search engine and determine a language associated with the search query (324). In some implementations, the advertisement system may be configured to determine the language of the search query by comparing terms in the search query to an electronic dictionary or database of terms in different languages (e.g., a dictionary associated with a translation system or tool). The advertisement system may determine that the base language of the search engine is different from the language associated with the search query (326) and may determine that the user understands both languages (328).

In one example implementation of process 320, a user may navigate to an English-language search engine interface and may conduct a search for the German word “blumen,” which translates to “flowers” in English. The advertisement system may determine that the user understands English because the user chose to use the English-language interface of the search engine. The advertisement system may determine that the user also understands German because the user chose to search for the German word “blumen” instead of the English word “flowers.” Based on the mis-match between the search engine base language and the base language of the search query, the advertisement system may determine that the user is bilingual and understands both English and German.

FIG. 3C is a flow diagram of an illustrative process 340 in which the languages understood by the user may be determined based on tasks previously performed by the user. The advertisement system may be configured to determine languages associated with tasks previously performed by the user (342). In some implementations, the tasks upon which the language determination is based may include previous searches performed by the user, electronic communications associated with the user, and/or other types of tasks. The advertisement system may be configured to determine that the user understands all of the languages associated with the previously performed tasks (344). For example, a user may perform one search in English and may later perform another search in Chinese. The advertisement system may be configured to determine that the user understands both English and Chinese based on these previous searches. The user may be allowed to enable and disable use of previous tasks in determining languages associated with the user. In some implementations, the advertisement system may be configured to receive and/or utilize only a portion of search queries and/or electronic communications for use in determining languages understood by the user. For example, the advertisement system may receive only a single word or few words of a search query or electronic communication, or the advertisement system may obtain terms from locations spread throughout an electronic communication (e.g., random locations) so as to make the subject or nature of the electronic communication indecipherable or difficult to decipher for the advertisement system.

FIG. 3D is a flow diagram of an illustrative process 360 in which the languages understood by a user may be determined by presenting content in multiple languages and identifying the content with which the user interacts. The advertisement system may be configured to provide advertisements or other types of content to the user in multiple languages (362). In some implementations, the languages used in providing content to the user may be determined based in part on information known about the user, such as citizenship or location information. For example, if it is known that the user is a citizen or resident of a country in which a large portion of the population is bilingual (e.g., understands both English and German), the advertisement system may be configured to present users with both English and German advertisements. The advertisement system may be configured to receive an indication of the advertisements or other content elements with which the user interacts (364). In some implementations, the advertisement system may be configured to determine that the user has interacted with a particular advertisement when the user selects a hyperlink associated with the advertisements. The advertisement system may be configured to determine that the languages understood by the user include the languages of any advertisements or other content elements with which the user interacts and may continue providing advertisements in those languages (366). If the user never interacts with advertisements in a particular language, the advertisement system may be configured to stop presenting advertisements in that language to the user. In some implementations, the advertisement system may be configured to present advertisements for a particular length of time or number of searching sessions before the system stops presenting advertisements in a particular language. This may help ensure that the user is ignoring the advertisements because the user does not understand the language of the advertisements and not merely because the user is not interested in the content of the particular advertisements.

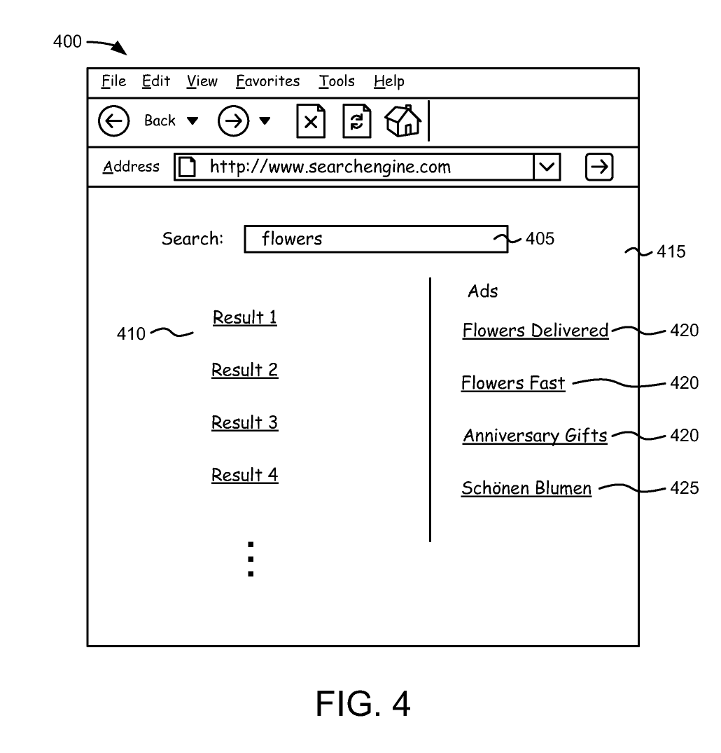

Referring now to FIG. 4, an example display image 400 of a search engine results interface through which content (e.g., advertising content) in multiple languages may be provided to a multilingual user is shown according to an illustrative implementation. Image 400 includes a results interface for an English-language search engine. The search engine interface includes a search field 405 that may be used to provide search queries to be processed by the search engine. Results of the search are shown in a results portion 410, and advertisements are provided in an advertisements portion 415.

Advertisements portion 415 of image 400 includes four advertisements based on the English-language search query of “flowers.” Three advertisements 420 are English-language advertisements relating to flowers. A fourth advertisement 425 is a German-language advertisement for “Schönen Blumen,” or “Pretty Flowers” in English. Advertisement 425 is presented based on the determination by the advertisement system that the user understands both English and German. The advertisement system may have determined that the user understands both English and German based on explicit input from the user, by previously presenting German-language advertisements to the user and identifying that the user interacted with the advertisements, or using another method described herein.

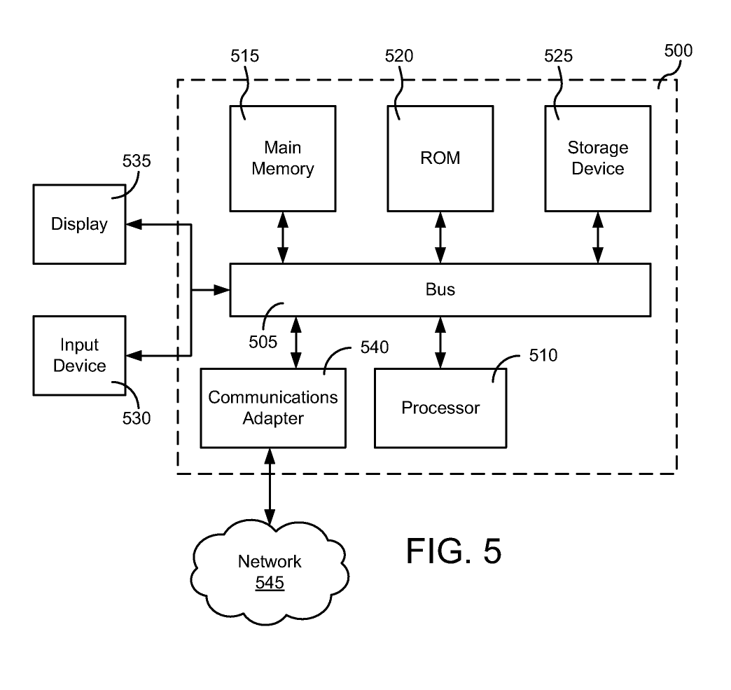

FIG. 5 illustrates a depiction of a computer system 500 that can be used, for example, to implement an illustrative user device 104, an illustrative advertisement system 108, an illustrative search engine 106, and/or various other illustrative systems that may be used in the implementation of an environment in which online advertisements may be provided as described in the present disclosure. The computing system 500 includes a bus 505 or other communication component for communicating information and a processor 510 coupled to the bus 505 for processing information. The computing system 500 also includes main memory 515, such as a random access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 510 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information, and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

In some implementations, the computing system 500 may include a communications adapter 540, such as a networking adapter. Communications adapter 540 may be coupled to bus 505 and may be configured to enable communications with a computing or communications network 545 and/or other computing systems. In various illustrative implementations, any type of networking configuration may be achieved using communications adapter 540, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. In alternative implementations, hard-wired circuitry may be used in place of or in combination with software instructions to implement illustrative implementations. Thus, implementations are not limited to any specific combination of hardware circuitry and software.

Although an example processing system has been described in FIG. 5, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
receiving a search query in the first language entered by the user into a search engine;
determining a plurality of languages understood by a user based on one or more inputs received from the user, the plurality of languages comprising a first language and a second language;
identifying, using at least one processing circuit, first advertising content in the first language based on the search query;
identifying, using the at least one processing circuit, second advertising content in the second language based on the search query; and
providing the first advertising content and the second advertising content to the user.

2. The method of claim 1, wherein determining the plurality of languages understood by the user comprises:
identifying a language associated with the search engine;
identifying a language associated with the search query;
determining that the language associated with the search engine and the language associated with the search query are different languages; and
determining that the plurality of languages understood by the user includes the language associated with the search engine and the language associated with the search query.

3. The method of claim 1, wherein determining the plurality of languages understood by the user comprises:
determining one or more languages associated with a plurality of historical tasks performed by the user; and
when the one or more languages associated with the plurality of historical tasks include two or more different languages, determining that the plurality of languages understood by the user includes the two or more different languages.

4. The method of claim 1, wherein determining the plurality of languages understood by the user comprises:
providing a plurality of advertising content elements to the user, each of the plurality of advertising content elements being associated with a different one of a plurality of languages;
determining two or more of the plurality of advertising content elements with which the user interacts; and
determining that the plurality of languages understood by the user includes the languages associated with the two or more of the plurality of advertising content elements with which the user interacts.

5. The method of claim 4, wherein the plurality of advertising content elements each comprise hyperlinks, and wherein determining two or more of the plurality of advertising content elements with which the user interacts comprises determining two or more advertising content elements for which the user selects the respective hyperlinks.

6. The method of claim 1, wherein determining the plurality of languages understood by the user comprises receiving a list of languages from the user and storing an indication that the user understands the languages on the list of languages in settings associated with the user.

7. The method of claim 1, wherein identifying second advertising content in the second language based on the search query comprises:
translating, using a machine translation performed by the at least one processing circuit, the search query into the second language; and
identifying the second advertising content in the second language based on the machine translated search query.

8. The method of claim 1, wherein identifying second advertising content in the second language based on the search query comprises:
translating one or more keywords associated with the second advertising content into the first language;
determining at least one of the one or more translated keywords associated with the second advertising content to be relevant to the search query; and
identifying the second advertising content in the second language based on the determination that the at least one of the one or more translated keywords associated with the second advertising content is relevant to the search query.

9. The method of claim 1, wherein providing the first advertising content and the second advertising content to the user comprises providing the first advertising content and the second advertising content within an advertisement portion of a single search result display screen.

10. The method of claim 9, further comprising translating, using the at least one processing circuit, the second advertising content from the second language into the first language before presenting the second advertising content to the user.

11. The method of claim 9, further comprising:
receiving a user selection of the second advertising content for translation; and
responsive to receiving the user selection, translating, using the at least one processing circuit, the second advertising content from the second language into the first language and presenting the translated second advertising content in the first language to the user.

12. The method of claim 1, wherein the first advertising content comprises a plurality of first advertising content items and the second advertising content comprises a plurality of second advertising content items, and wherein providing the first advertising content and the second advertising content to the user comprises:
ranking the first advertising content items and second advertising content items; and
providing the first advertising content items and the second advertising content items to the user in an order that is based on the ranking.

13. The method of claim 12, wherein the ranking is based on at least one of relevance of the items, bids associated with the items, a click through rate associated with the items, or translation confidence associated with the items.

14. A system comprising:
at least one computing device operably coupled to at least one memory and configured to:
receive a search query in the first language entered by the user into a search engine;
determine a plurality of languages understood by a user based on one or more inputs received from the user, the plurality of languages comprising a first language and a second language;
identify first advertising content in the first language based on the search query;
translate the search query into the second language;
identify second advertising content in the second language based on the translated search query; and
provide the first advertising content and the second advertising content to the user.

15. The system of claim 14, wherein the at least one computing device is configured to determine the plurality of languages understood by the user by:
identifying a language associated with the search engine;
identifying a language associated with the search query;
determining that the language associated with the search engine and the language associated with the search query are different languages; and
determining that the plurality of languages understood by the user includes the language associated with the search engine and the language associated with the search query.

16. The system of claim 14, wherein the at least one computing device is configured to determine the plurality of languages understood by the user by:
determining one or more languages associated with a plurality of historical tasks performed by the user; and
when the one or more languages associated with the plurality of historical tasks include two or more different languages, determining that the plurality of languages understood by the user includes the two or more different languages.

17. The system of claim 14, wherein the at least one computing device is configured to determine the plurality of languages understood by the user by:
providing a plurality of advertising content elements to the user, each of the plurality of advertising content elements being associated with a different one of a plurality of languages;
determining two or more of the plurality of advertising content elements with which the user interacts; and
determining that the plurality of languages understood by the user includes the languages associated with the two or more of the plurality of advertising content elements with which the user interacts.

18. The system of claim 17, wherein the plurality of advertising content elements each comprise hyperlinks, and wherein the at least one computing device is configured to determine two or more of the plurality of advertising content elements with which the user interacts by determining two or more advertising content elements for which the user selects the respective hyperlinks.

19. A computer-readable storage medium having instructions stored thereon that, when executed by a processor, cause the processor to perform operations comprising:
receiving a search query in the first language entered by the user into a search engine;
determining a plurality of languages understood by a user based on one or more inputs received from the user, the plurality of languages comprising a first language and a second language;
identifying first advertising content in the first language based on the search query;
identifying second advertising content in the second language based on the search query; and
providing the first advertising content and the second advertising content to the user.

20. The computer-readable storage medium of claim 19, wherein determining the plurality of languages understood by the user comprises:
identifying a language associated with the search engine;
identifying a language associated with the search query;
determining that the language associated with the search engine and the language associated with the search query are different languages; and
determining that the plurality of languages understood by the user includes the language associated with the search engine and the language associated with the search query.

21. The computer-readable storage medium of claim 19, wherein determining the plurality of languages understood by the user comprises:
determining one or more languages associated with a plurality of historical tasks performed by the user; and
when the one or more languages associated with the plurality of historical tasks include two or more different languages, determining that the plurality of languages understood by the user includes the two or more different languages.

22. The computer-readable storage medium of claim 19, wherein determining the plurality of languages understood by the user comprises:
providing a plurality of advertising content elements to the user, each of the plurality of advertising content elements being associated with a different one of a plurality of languages;
determining two or more of the plurality of advertising content elements with which the user interacts; and
determining that the plurality of languages understood by the user includes the languages associated with the two or more of the plurality of advertising content elements with which the user interacts.

23. The computer-readable storage medium of claim 19, wherein identifying second advertising content in the second language based on the search query comprises:
translating, using a machine translation performed by the at least one processing circuit, the search query into the second language; and
identifying the second advertising content in the second language based on the machine translated search query.

24. The computer-readable storage medium of claim 19, wherein identifying second advertising content in the second language based on the search query comprises:
translating one or more keywords associated with the second advertising content into the first language;
determining at least one of the one or more translated keywords associated with the second advertising content to be relevant to the search query; and
identifying the second advertising content in the second language based on the determination that the at least one of the one or more translated keywords associated with the second advertising content is relevant to the search query.
